(19) United States
(12) Patent Application Publication
(10) Pub. No.: US 2021/0254878 A1
(43) Pub. Date: Aug. 19, 2021

(54) SECURABLE TEMPERATURE CONTROLLED DELIVERY CONTAINER AND METHOD OF USING THE SAME

(71) Applicant: Clint Moore, Hillsboro, OH (US)

(72) Inventor: Clint Moore, Hillsboro, OH (US)

(21) Appl. No.: 17/126,454

(22) Filed: Dec. 18, 2020

Related U.S. Application Data
(60) Provisional application No. 62/977,233, filed on Feb. 15, 2020.

(51) Int. Cl. F25D 3/08; G07C 9/00; H02J 50/10

(52) U.S. Cl. CPC F25D 3/08; G07C 9/00896; G07C 2009/0092; H02J 50/10; G07C 9/00658

(57) ABSTRACT

This invention relates to a portable temperature-controlled container comprising a body defining a storage compartment and an opening to permit access to the storage compartment, with a lid selectively covering the opening in the body and a camera integrated into an external surface of the body. The container further has a control panel integrated into the external surface of the body, wherein the control panel locks and unlocks the lid. A speaker is integrated into the external surface of the body, wherein the speaker is configured to provide updates or communication from a person sending the portable temperature-controlled container to its destination and the control panel only unlocks the lid upon the entering of a specific sequence of inputs.

### CROSS-REFERENCE TO RELATED APPLICATIONS

The present application claims the benefit of priority to U.S. Provisional Patent Application 62/977233, filed Feb. 15, 2020 with first named inventor Clint Moore.

### TECHNICAL FIELD

This invention relates to a portable temperature-controlled container. More specifically, the present invention relates to a portable temperature-controlled container with specific user interface options and goods monitoring systems.

### BACKGROUND

The transportation of highly-temperature-sensitive goods, whether they be food, drinks, medicine, or other items, is a major problem facing the distributers of those goods and the workers charged with administering those goods. If these goods are subjected to a temperature outside their acceptable temperature storage range, even for a short period of time, the goods may spoil. In some instances, spoiling will result in the goods being less effective than would otherwise be the case and in other instances, the goods may become dangerous to administer and they may represent a significant health risk to the intended recipient. Accordingly, it is essential that the distributers of the goods ensure that the goods are maintained within the desired temperature range from the time of production to the time of administration.

Further, as shipping becomes more common and anonymous, trust between the supplier, end customer, and logistics in between the two must also increase. With packages left unattended on doorsteps and in other locations, having accountability for the location and status for each package is important.

### SUMMARY

This invention relates to a portable temperature-controlled container comprising a body defining a storage compartment and an opening to permit access to the storage compartment, with a lid selectively covering the opening in the body and a camera integrated into an external surface of the body. The container further has a control panel integrated into the external surface of the body, wherein the control panel locks and unlocks the lid. A speaker is integrated into the external surface of the body, wherein the speaker is configured to provide updates or communication from a person sending the portable temperature-controlled container to its destination and the control panel only unlocks the lid upon the entering of a specific sequence of inputs. The portable temperature-controlled container of claim 1, further comprising at least one inlet handle integrated into the external surface of the body.

In additional embodiments, the portable temperature-controlled container of further comprises a charging port integrated into the external surface of the body, whereby the speaker, control panel, or any other element of the container may be charged and recharged.

Still further, the container may comprise a bottom charging contact, configured to interface with a charging hub to wirelessly charge the speaker, control panel, or any other element of the container.

Additionally or alternatively, the portable temperature-controlled container further comprises a GPS tracking element. The GPS tracking element may comprise a transmitter and transmits time and location to an end user. Additionally, there may be a thermometer inside the body and transmitting the real-time temperature to an end user. The control panel of the container may unlock the lid after the internal temperature reaches a predetermined temperature.

In yet more embodiments, the portable temperature-controlled container has a removable wall within the storage compartment. These walls of the storage compartment may be insulated. The removable wall or walls of the storage compartment may further comprise a heating or cooling element. The removable wall, along with the lid and the interior walls of the storage volume, may define two smaller volumes within the storage compartment and the temperatures of the two smaller volumes may be held at different levels from one another.

In further embodiments, the portable temperature-controlled container may have its floor of the storage compartment further comprising a heating or cooling element.

### BRIEF DESCRIPTION OF THE DRAWINGS

Non-limiting and non-exhaustive embodiments of the invention disclosed are described, including various embodiments of the disclosure with reference to the figures, in which:

FIG. 1 is a side view of an embodiment of a container;

FIG. 2 is a top view of an embodiment of the container in the “open” position;

FIG. 3 is a front view of an embodiment of the container;

FIG. 4 is a side view of an embodiment of the container;

FIG. 5 is a top view of an embodiment of the container;

FIG. 6 is a top view of an embodiment of a charging hub for use with the container; and

FIG. 7 is a top view of an embodiment of a cover for use with the container.

### DETAILED DESCRIPTION OF THE DRAWINGS

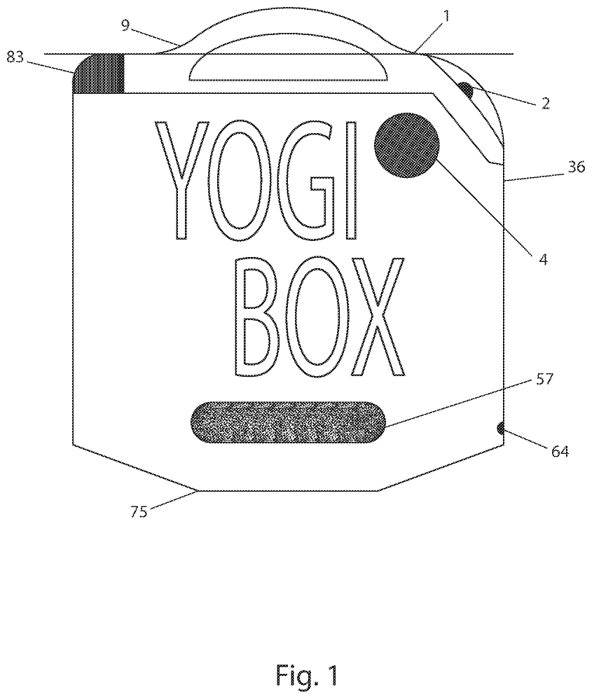

FIG. 1 shows an embodiment of a container 1. While the embodiment shown in FIG. 1 is of a substantially rectangular shape, the container 1 may be any substantially circular, triangular, pentagonal, hexagonal, or any other shape conducive to holding one or more items within it. Similarly, while the container 1 is shown to be chamfered and rounded, alternative embodiments may have no chamfering or less chamfering, no rounding or less rounding, or any combination thereof than shown in the Figures.

As shown in FIGS. 1, 3, and 4, the container 1 may comprise a camera 2, a control panel 36, a speaker 4, at least one inset handle 57, a charging port 64, a bottom charging contact 75, a lid hinge 83, a GPS tracking element 103, and a lid 9. The camera 2 may be any commercially available optical device configured to obtain video and/or pictures and store and transmit the same. The camera 2 may be powered by any known power source, including but not limited to batteries, solar power, and kinetic energy. In certain embodiments, the camera 2 is powered by the same battery powering the other elements of the container 1. In other embodiments, there may be a plurality of cameras 2.

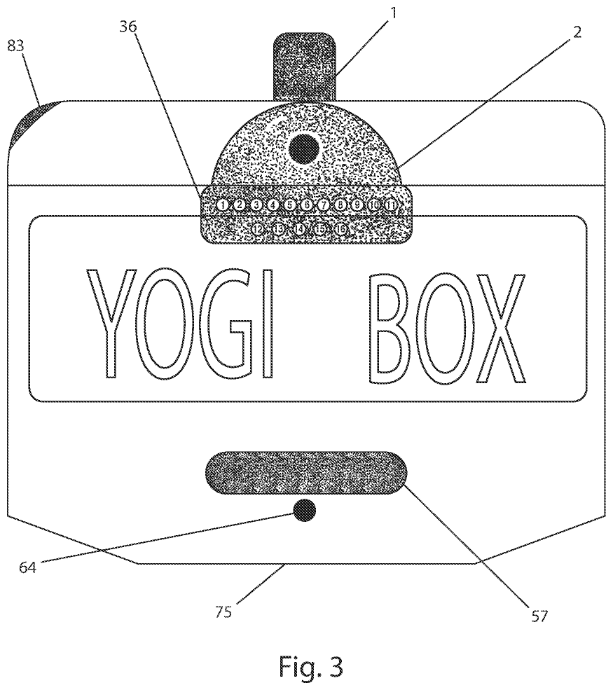

The control panel 36, as shown in FIG. 3, may be a series of numbered buttons. These numbered buttons may be in numeric order but may be any type of numeric, alphabetic, or other type of character. As shown, there are 16 numbered buttons on the control panel 36, but there may be more or fewer buttons. Additionally or alternatively, the control panel 36 may comprise one or more touch screens with which a user may interface. In embodiments with a touchscreen, the touchscreen may comprise a video screen.

The control panel 36 locks and unlocks the lid 9. The container 1 allows a customer to view the locking of the lid 9. The container 1 may comprise a transmitter, integrated with either the control panel 36 or GPS tracking element 103 to the customer and/or the owner of the container 1. In a preferred embodiment, the camera 2 of the container 1 would capture video of the contents of the container 1 being loaded into the container 1 before delivery. The video may be transmitted to the customer to view via a website, a phone application, or upon delivery on the touchscreen of the control panel 36 in embodiments of the container 1 with touchscreens. The control panel 36 may be loaded with a code shared from the owner to the customer to lock and unlock the container 1 and release the lid 9. Additionally or alternatively, the control panel 36 may have a command line to open the lid 9. The transmitter may connect to and from smart technologies as exemplified by trademarked names Alexa, Siri, and Bixby mobile device home devices. The connected digital interface would allow the user and/or the owner to view the location, volume, battery charge, temperature, and time en route. Additionally or alternatively, the control panel 36 and/or the connected digital interface would allow the user to send payment for services and tips.

The speaker 4 may be used to communicate messages between the customer and the owner. In some embodiments, the speaker 4 may further comprise a microphone. The speaker 4 may be able to reproduce standard and preloaded messages. Additionally or alternatively, the speaker 4 may allow the customer and the owner to communicate in real time.

The GPS tracking element 103 may be connected to the transmitter to transmit location and time date to the customer and/or the owner.

The lid 9 is affixed to the rest of the container 1 via the lid hinge 83. The lid hinge 83 may be a standard hinge, a hook and clasp, or any other method of removably affixing the lid 9 to the rest of the container 1.

The container 1 may have one or more inset handles 57. The inset handles 57 may be spaced around the exterior of the container 1 so as to allow a user to more easily carry the container 1. While only one inlet handle 57 is shown on each side, there may be more or fewer inlet handles 57 on each side of the container 57. The inset handles 57 may be designed to be carried by standard human hands. Additionally or alternatively, the inset handles 57 may be configured to interface with a drone, a cart, or any other mobility device. It is contemplated that the container 1 may be delivered via airborne or land drone from the owner to the customer and back.

The charging port 64 may be a standard charging port capable of receiving USB-C, USB-A, or microUSB, miniUSB, or any other type of power cord to provide power to the battery within the container 1. The charging port 64 may have a cover so as to be protected from dust, water, and other elements.

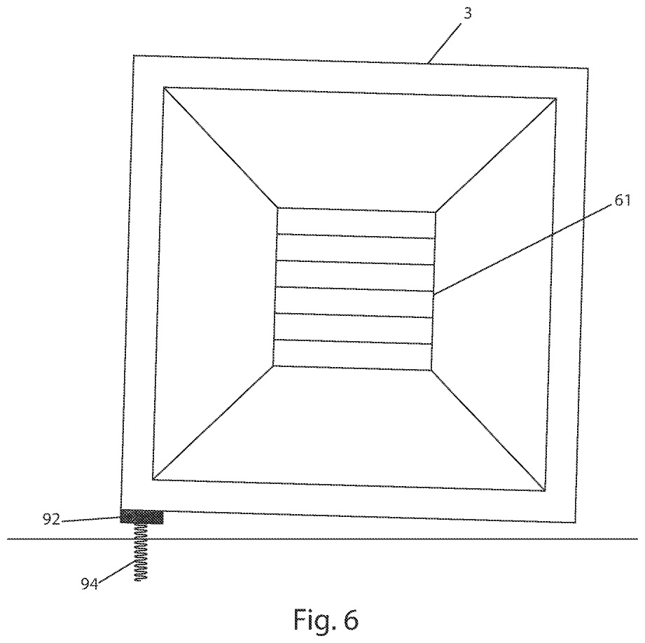

The bottom charging contact 75 is designed to interface with the charging hub 61 of FIG. 6. The charging hub 61 may wirelessly charge the battery within the container 1. The charging hub 61 may function similarly to the wireless charging device of US20150002088A1, which is herein incorporated by reference. While the charging hub 61 is shown to be rectangular, it may be any shape conducive to allowing the container 1 to rest upon it. In an exemplary embodiment, the charging hub 61 may plug into standard electrical outlets (110 volts) as well as 12 volt plugs. The charging hub 61 may comprise signal lights to display the level of charge left and whether the charging hub 61 is currently charging the container 1. Battery level may also be displayed on the control panel 36.

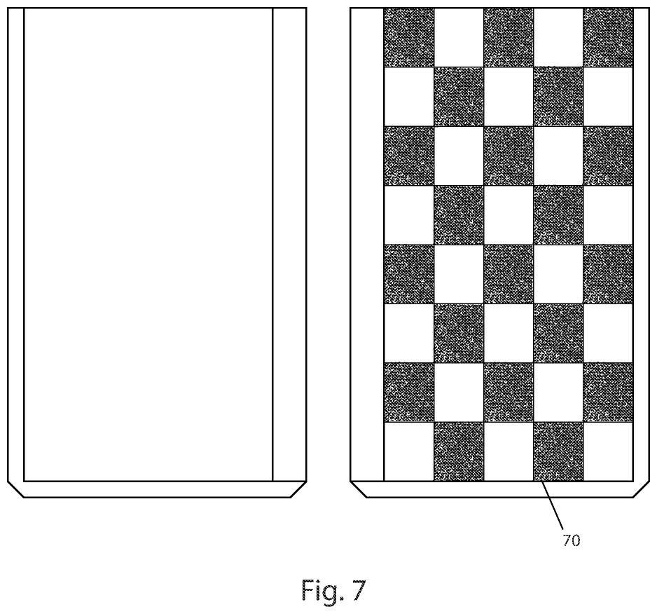

The container 1 may have branding on the outside as shown in FIGS. 1 and 3. with the phrase “YOGI BOX” emblazoned on the particular containers 1. This branding may light up in various colors. Additionally or alternatively, it may be removable. Further, the container 1 may be covered by a cover 70 as shown in FIG. 7.

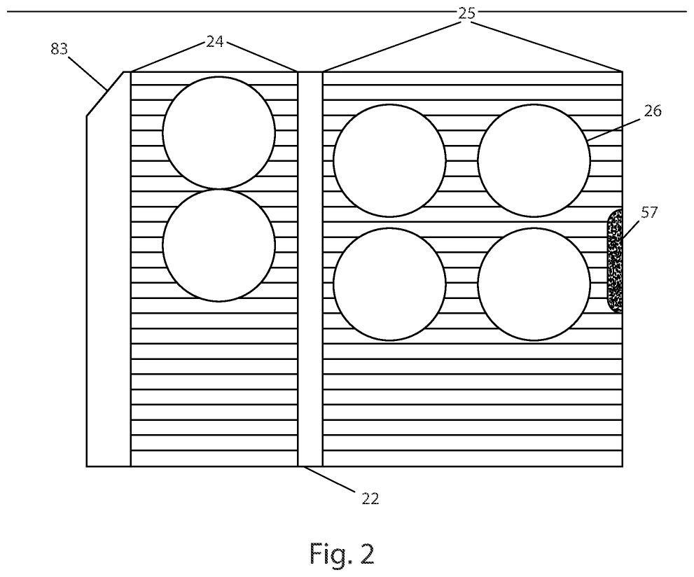

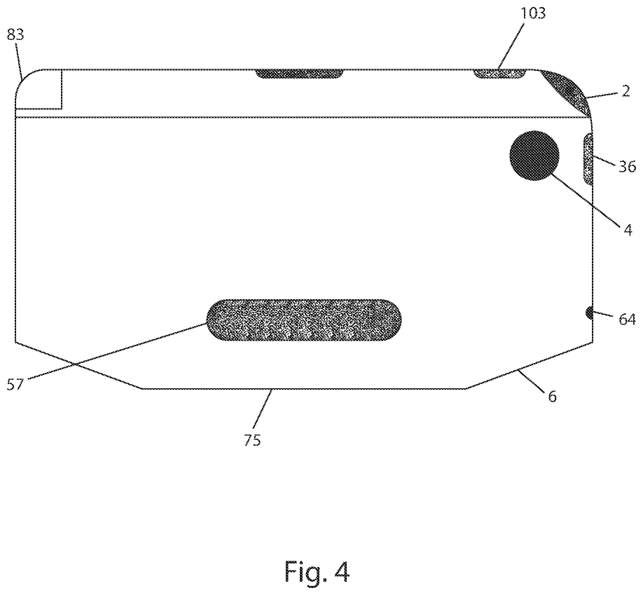

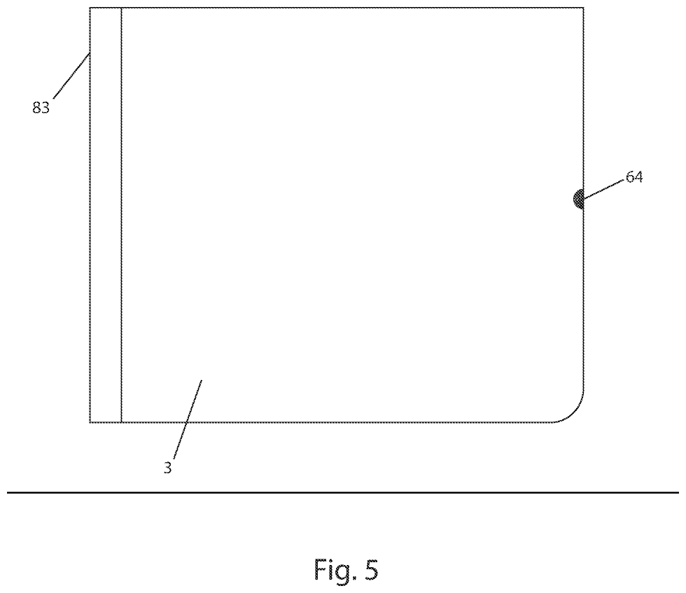

FIG. 2 shows the inside of a container 1. The container 1 may further comprise a divider 22, which divides the container 1 into a first side 24 and a second side 25. The divider 22 and the container 1 may be provide insulation. In some embodiments, the container 1 may comprise an internal bottom with cutouts 26 for cans, bottles, or other items. While the cutouts 26 are shown to be circular, they may be any shape and number to fit a desired transport use. The first side 24 would be held at a first temperature via heating or cooling powered by the battery within the container 1. The second side 25 would be held at a second temperature via heating or cooling powered by the battery within the container 1. In the embodiments shown in FIGS. 4 and 5, there is no divider 22 and therefore only a first side 24 held at a first temperature. By having divided sections of the container 1 held at various temperatures, the container 1 may be able to be used to deliver various food items, medicines, organs, or other items needing specialized temperature control. Temperature may be controlled via heating, freon, or dry ice, ice packs, or any other means within the container 1 in addition to the powered heating and cooling. The temperatures may vary in response to outside temperature of the container 1. Additionally or alternatively, the container 1 may vary temperature based on height and location to control internal temperature.

The method of use would be to begin with a powered container 1, opening the lid 9, inserting at least one item into the container 1, using the control panel 36 to select at least one temperature for the container 1 to maintain the at least one item, closing and locking the lid 9, sending a code to an end user to unlock the lid 9 via the control panel 36, delivering the container 1 to the end user, the end user unlocking the lid 9 with the code provided by the owner, opening the lid 9 and removing the at least one item, closing the lid 9, and the container 1 being returned to the owner. The step of payment may be added anywhere along the chain and in multiples. There may be multiple items held at multiple temperatures in multiple sides 24, 25 of the container 1. Additionally or alternatively, the temperature may be controlled to fluctuate during delivery. Any interface with the control panel 36 may be manual, via the Internet, via an app, or any other way of communicating to the control panel 36. Delivery may be manual, by drone, hand delivered, or any method to delivery the container 1 to and from the end user. The additional steps of covering and uncovering the container 1 with the blanket 70 may be added before any step.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

Certain terminology is used in the disclosure for convenience only and is not limiting. The words “left”, “right”, “front”, “back”, “upper”, and “lower” designate directions in the drawings to which reference is made. The terminology includes the words noted above as well as derivatives thereof and words of similar import.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A portable temperature-controlled container comprising:
a body defining a storage compartment and an opening to permit access to the storage compartment;
a lid selectively covering the opening in the body;
a camera integrated into an external surface of the body;
a control panel integrated into the external surface of the body, wherein the control panel locks and unlocks the lid;
a speaker integrated into the external surface of the body, wherein the speaker is configured to provide updates or communication from a person sending the portable temperature-controlled container to its destination; and wherein the control panel only unlocks the lid upon the entering of a specific sequence of inputs.

2. The portable temperature-controlled container of claim 1, further comprising at least one inlet handle integrated into the external surface of the body.

3. The portable temperature-controlled container of claim 1, further comprising a charging port 64 integrated into the external surface of the body, whereby the speaker, control panel, or any other element of the container may be charged and recharged.

4. The portable temperature-controlled container of claim 1, further comprising a bottom charging contact, configured to interface with a charging hub to wirelessly charge the speaker, control panel, or any other element of the container.

5. The portable temperature-controlled container of claim 1, further comprising a GPS tracking element.

6. The portable temperature-controlled container of claim 5, wherein the GPS tracking element further comprises a transmitter and transmits time and location to an end user.

7. The portable temperature-controlled container of claim 6, further comprising a thermometer inside the body and transmitting the real-time temperature to an end user.

8. The portable temperature-controlled container of claim 1, further comprising a removable wall within the storage compartment.

9. The portable temperature-controlled container of claim 8, wherein the removable wall and/or the walls of the storage compartment are insulated.

10. The portable temperature-controlled container of claim 9, wherein the removable wall or walls of the storage compartment further comprise a heating or cooling element.

11. The portable temperature-controlled container of claim 7, wherein the floor of the storage compartment further comprises a heating or cooling element.

12. The portable temperature-controlled container of claim 10, wherein the removable wall, along with the lid and the interior walls of the storage volume, defines two smaller volumes within the storage compartment and the temperatures of the two smaller volumes are held at different levels from one another.

13. The portable temperature-controlled container of claim 7 wherein the control panel unlocks the lid after the internal temperature reaches a predetermined temperature.

14. The portable temperature-controlled container of claim 5, wherein the body is configured to be delivered by drone.
